(19) United States
(12) Patent Application Publication
(10) Pub. No.: US 2025/0357758 A1
(43) Pub. Date: Nov. 20, 2025

(54) GRID-FORMING CONTROL DESIGN

(71) Applicant: University of South Florida, Tampa, FL (US)

(72) Inventors: Lingling Fan, Tampa, FL (US); Zhixin Miao, Tampa, FL (US)

(21) Appl. No.: 19/207,618

(22) Filed: May 14, 2025

Related U.S. Application Data
(60) Provisional application No. 63/648,539, filed on May 16, 2024.

(51) Int. Cl. H02J 3/16; H02J 3/38

(52) U.S. Cl. CPC H02J 3/16; H02J 3/38; H02J 2300/24; H02J 2300/28

(57) ABSTRACT

In some aspects, the techniques described herein relate to a grid forming controller with decoupled voltage control including: a decoupled voltage control as an outer control unit; a power-based synchronization unit; and an inner current control unit, wherein the controller receives measurements from an inverter, the measurements including three-phase instantaneous PCC voltage and three-phase instantaneous converter currents, and outputs pulse width modulation signals for the inverter.

### CROSS-REFERENCE TO RELATED APPLICATIONS

This application claims benefit of, and priority to, U.S. Provisional Patent Application No. 63/648,539 filed on May 16, 2024, titled “A Novel Grid-Forming Design.” The contents of which is hereby incorporated by reference in its entirety.

### BACKGROUND

Synchronous generators have been the dominant electricity generation technology in the past century. In the recent decade, power electronic converter technology becomes mature. In turn, large-scale solar photovoltaic or wind farms, each with capacities of several hundred megawatts, have been connected to bulk power systems using DC-AC converters as interfaces.

To ensure high penetrations of renewable energy sources into power grids, those inverter-based resources (IBRs) have to provide grid support through their interfacing inverters. Important grid support functions include frequency and voltage regulation, fault ride-through capability, stability enhancement, etc. Legacy IBR power plants lack frequency support capability since their inverters were designed to follow the main grid using grid-following control (GFL). By synchronizing with the grid's voltage using phase-locked loops (PLLs), these legacy IBRs operate as current sources, injecting real and reactive currents accordingly. To this end, the research community has recently invested heavily in grid-forming (GFM) control pilot projects. Grid-forming control aims to replace the traditional grid-following control, which is based on phase-locked loop (PLL) for synchronization.

### SUMMARY

In some aspects, the techniques described herein relate to a grid forming controller with decoupled voltage control including: a decoupled voltage control as an outer control unit; a power-based synchronization unit; and an inner current control unit, wherein the controller receives measurements from an inverter, the measurements including three-phase instantaneous point of common coupling (PCC) voltage and three-phase instantaneous converter currents, and outputs pulse width modulation signals for the inverter.

In some aspects, the techniques described herein relate to a grid forming controller, wherein the outer control unit includes a d-axis control component and a q-axis control component, wherein the d-axis outer control component drives the q-axis component of the voltage vector to zero.

In some aspects, the techniques described herein relate to a grid forming controller, wherein the q-axis outer control regulates reactive power or voltage magnitude and it includes a proportional integral (PI) controller.

In some aspects, the techniques described herein relate to a grid forming component, wherein the outer PI controller of the q-axis control component outputs a q-axis component of the current reference.

In some aspects, the techniques described herein relate to a grid forming component, wherein the q-axis inner control unit receives the q-axis component of the current reference and ensures the q-axis current component tracking the reference.

In some aspects, the techniques described herein relate to a grid forming controller, wherein the d-axis outer control includes a PI controller, and further wherein the PI controller receives as an input a negative of the q-axis component of the voltage vector.

In some aspects, the techniques described herein relate to a grid forming controller, wherein the PI controller of the d-axis outer control component outputs a real current reference.

In some aspects, the techniques described herein relate to a grid forming component, wherein the d-axis inner current control receives the d-axis (or real) current reference and ensure the d-axis current components tracking the reference.

In some aspects, the techniques described herein relate to a grid forming controller, wherein the wherein the power-based synchronization unit generates a synchronization angle based on a power output from the inverter and sets up the dq frame.

In some aspects, the techniques described herein relate to a grid forming controller for an inverter, wherein the inverter is associated with one or more of a solar panel, a wind turbine, or a battery.

Additional advantages will be set forth in part in the description that follows, and in part will be obvious from the description, or may be learned by practice of the aspects described below. The advantages described below will be realized and attained by means of the elements and combinations particularly pointed out in the appended claims.

It is to be understood that both the foregoing general description and the following detailed description are exemplary and explanatory only and are not restrictive of the systems and methods as claimed.

### BRIEF DESCRIPTION OF THE DRAWINGS

The accompanying figures, which are incorporated in and constitute a part of this specification, illustrate several aspects of the disclosure, and together with the description, serve to explain the principles of the disclosure.

FIGS. 1A and 1B are illustrations of a circuit and the control structure of a grid-following control;

FIGS. 2A and 2B are illustrations of phasor diagrams for two cases;

FIGS. 3A and 3B illustrate the electromagnetic transient simulation results of an inverter-based resource (IBR) riding through a low-voltage fault;

FIG. 4 is an illustration of an example single loop GFM;

FIG. 5 illustrates the control structures of the three types of GFM;

FIGS. 6A-6D illustrate low-voltage ride through tests for the four IBRs described herein;

FIGS. 7A-7D illustrate simulation results of an IBR radially connected to a 50% compensated line at 0.5s;

FIG. 8 is an illustration of a power-angle feedback system representing an RLC circuit driven by a voltage source equipped with power-based synchronization;

FIGS. 9A and 9B are illustrations of simulation results;

FIG. 10 is an illustration of the experimental results of switching back and forth of the control mode from one to another for grid-connected operation; and

FIG. 11 shows an example computing environment in which example embodiments and aspects may be implemented.

### DETAILED DESCRIPTION

### 1. Conventional IBR Control and Operation Challenges

### 1.1 a Brief History of Current Vector Control

Many renewable energy sources rely on inverters to be interfaced to the AC grid. Those sources are terms as inverter-based resources or IBRs. Vector control has been popularly used in those grid-tied inverters to provide real power (DC-link voltage) and reactive power (or voltage) regulation. They have two distinct features: (i) cascaded control structures with inner current control to tightly regulate currents, and (ii) decoupled control objectives realized by real and reactive current regulation. The first feature is important for inverters as power electronic switches are very sensitive to overcurrent.

Applications of vector control appeared first in AC motor drives. In the early days, to adjust an induction motor's torque, single-variable scalar control, e.g., volt/Hz control, has been used to keep a constant flux while changing the stator's voltage magnitude and frequency. Scalar control is not precise and fast enough. In 1968, K. Hasse and F. Blaschke pioneered vector control, also known as field-oriented control. The philosophy of vector control is to represent three-phase stator currents as a rotating vector with two orthogonal components—d and q—where the d-axis aligns with the rotor flux and the q-axis is orthogonal to it. Flux is regulated via the d-component, while torque is controlled through the q-component.

Vector control became popular after the commercialization of microprocessors in the 1980s. When designing controls for grid-tied inverters, it was natural to adopt a vector control structure. On the other hand, torque and flux regulation is replaced by real and reactive power regulation. In a popular paper “Overview of control and grid synchronization for distributed power generation systems” by Frede Blaabjerg and co-authors published in 2006, the cascaded vector control structure for grid-tied inverters is considered as classic approach. A notable feature of vector control is its use of a phase-locked loop (PLL) to track and align with the point of common coupling (PCC) voltage space vector. The current vector is then viewed in the rotating frame established by the PLL, with the d-axis aligned to the voltage vector at steady state, and the q-axis leading and orthogonal to the d-axis. It is obvious that the d-axis component of the current is proportional to the real power. Hence, the d-axis current is equivalent to real current. The q-axis current is proportional to the reactive power and equal to the negative of the reactive current.

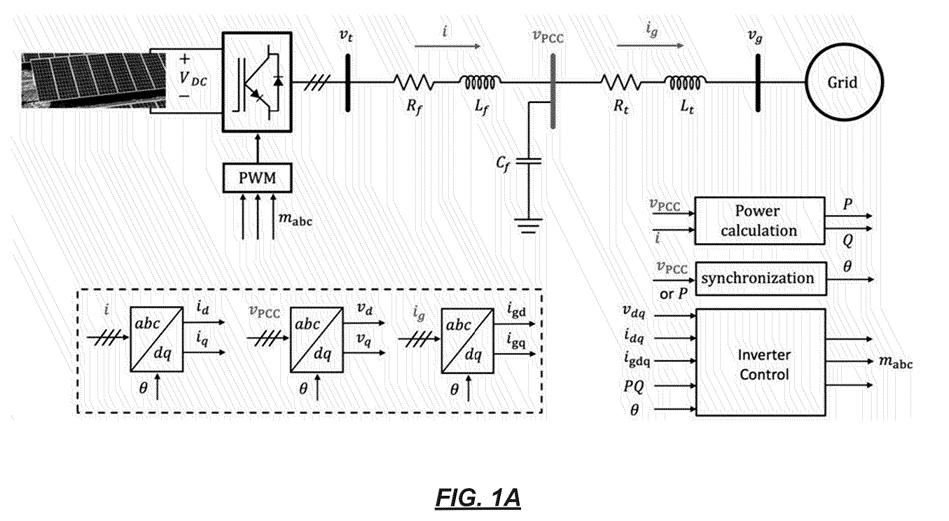

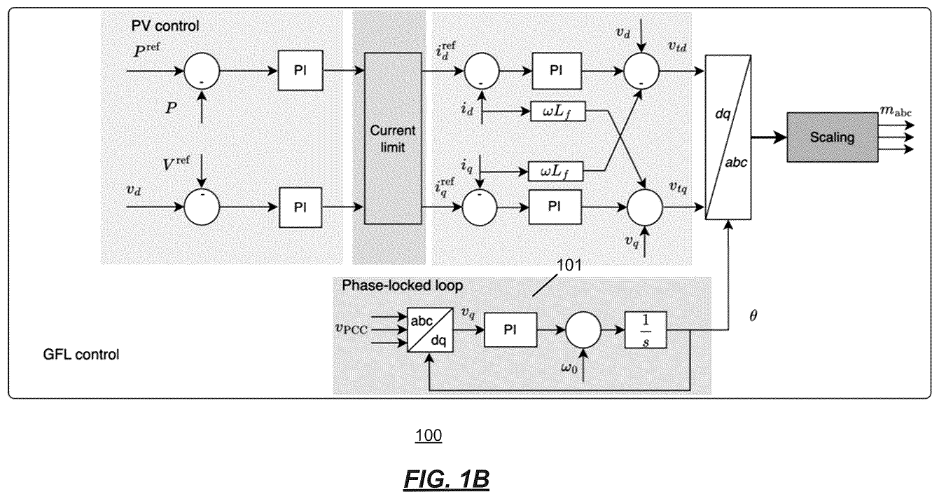

FIGS. 1A and 1B are illustrations of circuits showing the control structure of a grid-following control. The dq frame is designated to have the d-axis aligned with the PCC voltage vector through a PLL 101 of the circuit 100. This is achieved by enforcing the projection of the voltage vector on the q-axis, or its q-axis component to zero. Essentially, the PLL 101 generates an angle that tracks the phase angle of the PCC bus voltage-a ramping signal. While it is common practice to use a proportional-integral (PI) control to track a constant signal, tracking a ramping signal requires the use of double integrators. This is why the PLL 101 incorporates both a PI controller and an additional integrator. By feedforwarding the PCC bus voltage, the current control ensures that the converter's current closely follows the current reference, essentially behaving as a current source. The bandwidth of the current control is typically set to be above 150 Hz. It is easy to set limits on current references, and with precise current control, the converter's current measurements will remain within these limits. The outer controls generate the real and reactive current orders: real power regulation determines the real current reference, while reactive power or voltage regulation determines the reactive current reference.

### 1.2 Operational Challenges in Weak Grids

In the last decade, large-scale IBRs have been deployed in power grids worldwide. Many IBR power plants operate at the hundred-megawatt scale and are directly connected to transmission grids through step-up transformers. Compared to distributed generators, those power plants exert a much more substantial influence on power grid dynamics. Many IBRs are located in areas of weak grid strength, where maintaining stability and synchronization after faults becomes a significant challenge.

PLL or voltage-based synchronization has been identified as the unit that is vulnerable to weak grid operating conditions, according to North American Electric Reliability Corporation (NERC)'s reliability guideline published in 2017. Weak grid conditions make voltage more sensitive towards real and reactive power injection from IBRs. Therefore, voltage instability is a significant challenge which manifests as either voltage collapse or voltage oscillations. Additionally, weak grid conditions may lead to PLL loss of synchronism for a low-voltage fault in the grid. When an IBR operates as a current source, a sudden drop in the grid voltage will cause a sharp increase in the terminal voltage angle of the IBR. Consequently, the PLL's angle also rises. Compared to synchronous generators, this angle deviation can be significantly larger. In some cases, the IBR's protection systems may trip the unit if the PLL angle experiences a substantial deviation in a few cycles. A notable example is the 2021 Texas Odessa Disturbance, during which a solar PV plant located 200 miles from the fault on the transmission grid was tripped due to a large PLL angle deviation.

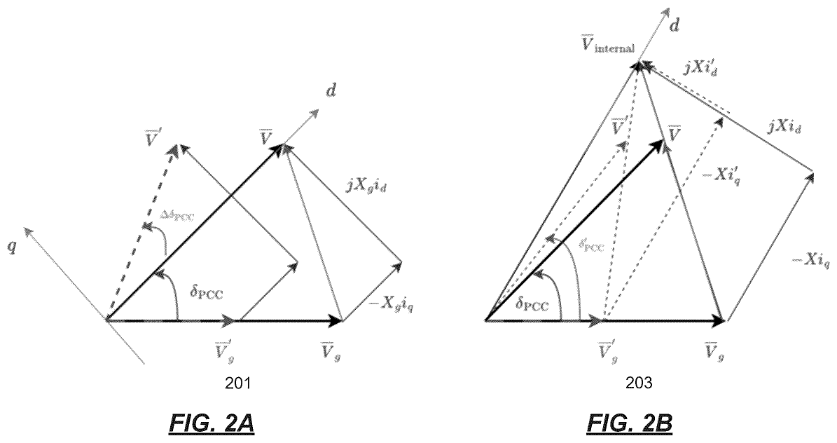

FIGS. 2A and 2B are illustrations of phasor diagrams for two cases. FIG. 2A illustrates current source and FIG. 2B illustrates voltage source. In FIG. 2A, X is the grid reactance. In FIG. 2B, X is the sum of the grid reactance and the source reactance.

The low-voltage ride through challenge is illustrated by the phasor diagram 201 shown in FIG. 2A. If the inverter has a tight current control, it operates as a current source. Upon a grid voltage dip, the PCC bus voltage magnitude drops and its angle increases. The PLL follows the PCC bus voltage angle. If the real current also increases, the angle will be even larger, creating difficulty of synchronism. On the other hand, if the IBR operates as voltage source, its internal voltage vector will not change suddenly. Upon the grid voltage dip, the PCC bus voltage vector will be subject to much slighter angle increase, as shown in the phaser diagram 203 of FIG. 2B.

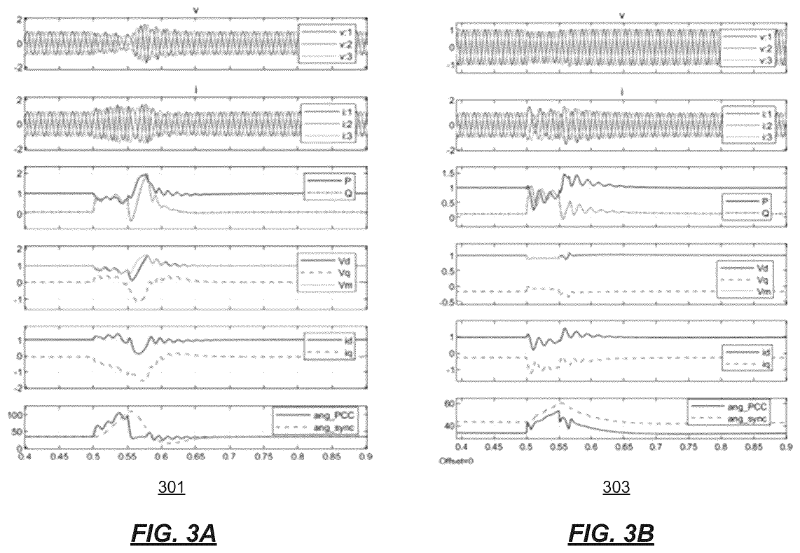

FIGS. 3A and 3B illustrate the electromagnetic transient (EMT) simulation results of an IBR riding through a low-voltage fault. FIG. 3A shows a graph 301 including results for a GFL, while FIG. 3B shows a graph 303 including results for a GFM virtual admittance control. The grid strength is set as short circuit ratio at 2. A 50% dip is applied at the grid voltage at 0.5 s. The GFL-IBR is in voltage control mode and the voltage control is set to inject more reactive current into the grid during the fault. This helps ride through the fault. On the other hand, the angles rise more than 50 degrees in three cycles. After the initial sharp rise following a sudden grid voltage dip, the PCC bus voltage phase angle continues to rise. This subsequent increase is driven by the real power regulation control logic. As real power decreases following the dip, the real current reference rises, causing the real current to increase, which in turn keeps the PCC bus angle increasing. The large angle rise leads to very significant post-fault recovery transients. When the fault is cleared, the PCC bus voltage angle immediately reduces back to the pre-fault value, while its magnitude experiences overvoltage for another several cycles, mainly due to the significant angle difference between the synchronism frame and the PCC bus voltage vector.

It can be seen that the control logic of using real power regulation to adjust real current injection is not helpful to ride through low-voltage faults. A large angle deviation during the fault is also not good for fault recovery. Therefore, to ride through low-voltage fault, a reasonable strategy is to reduce the real current injection upon grid voltage dip. This is exactly what a voltage source-based IBR's behavior, as shown in FIG. 2B and FIG. 3B. While the PCC bus voltage angle also rises sharply upon a grid voltage dip, the overall increase of the angles in three cycles after the fault is limited to less than 20 degrees. The post-fault transients are also insignificant without overvoltage.

### 2. a Variety of Grid-Forming Controls

Since 2010, efforts have been put into designing inverters and make inverters more like a voltage source with power-based synchronization, similar to a synchronous generator. In addition to stability enhancement in weak grids, providing frequency and voltage regulation has been pushed forward for IBRs to have advanced grid support capability. In the literature, many types of grid-forming control design have been proposed, and they can be categorized into two groups: without and with inner current control.

The first type tries to emulate the converter as a synchronous generator. This type may also be referred to single-loop GFM. FIG. 4 is an illustration of an example single loop GFM 400. In FIG. 4, the inverter's voltage magnitude is regulated to maintain a constant PCC bus voltage and the angle of the inverter is regulated through either power-frequency droop-based control or swing dynamics-based control. While the converter behaves as a synchronous generator, this type of control lacks the capability to enforce current limits. Therefore, additional control unit, e.g., virtual impedance is necessary to limit the current.

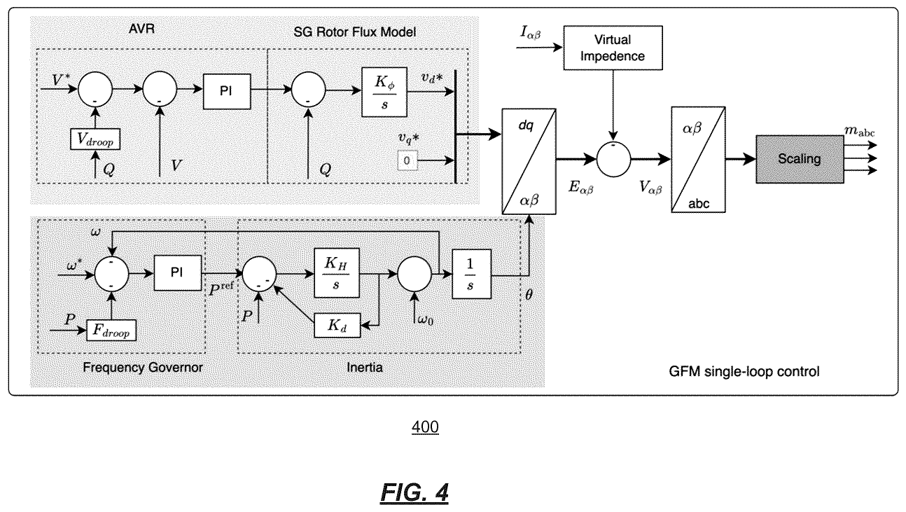

The second type, also called multi-loop GFM, features inner current control, which allows for easy enforcement of current limits. Three outer control designs of the multi-loop GFM are described below and illustrated in FIG. 5. These include a coupled voltage control 501, a virtual admittance control 503, and a decoupled voltage control 505.

FIG. 5 illustrates the control structures of the three types of GFM. They all have three units: the inner current control, power-based synchronization, and the outer control. It can be seen that the coupled voltage type 501 requires an additional current sensor, while the other two can be realized using the same sets of sensors of a grid-following controller.

### 2.1 Coupled Voltage Control

With the real power regulation realized through the synchronizing unit of the coupled voltage controller 501, the outer control is left to enforce the voltage of the PCC bus to follow its order. Since there are dq voltage control components, the d-axis control is to follow the magnitude order while the q-axis control is to force the q-axis voltage component to zero. In summary, this controller still operates in a dq frame aligned with the PCC bus voltage space vector. However, instead of using a PLL to establish the dq frame, it relies on a power-based synchronization unit. In a grid-following control structure 100, a PLL 101 ensures alignment between the reference frame and the PCC bus voltage vector. In the coupled voltage controller 501 setup, this alignment is achieved through the q-axis outer control by forcing the q-axis voltage component to zero.

The outer voltage control is designed based on a plant model that captures the dynamics of the shunt capacitor filter, with dq capacitor currents as inputs and dq capacitor voltages as outputs. This plant model forms a two-by-two coupled system. The outer control generates the dq capacitor current references from the dq voltage measurements. Through compensating the cross-coupling terms, the plant model further converts to two decoupled single-input single-output systems. The design is based on the two simple systems and the PI controller parameters can be set to achieve desired bandwidths. The coupled voltage control can achieve very fast angle tracking and frame alignment.

Since the outer voltage control's outputs are dq capacitor current references, to have converter current references, the grid current is added to the capacitor current references. Therefore, an additional current sensor measuring the current flowing to the grid is necessary. This results in extra costs in hardware.

Second, interactions between the outer voltage control and the synchronizing control are known issues, which may lead to when such GFM operating in strong grids. In this control, the synchronizing angle is generated by the power-based synchronization unit, which directly influences the PCC bus voltage's projection on the q-axis. A change in the synchronizing angle leads to changes in both the real and reactive currents through the coupling term and the q-axis PI controller. While the real current change ensures a stable feedback system, the reactive current change introduces an unstable mechanism. Take the example of a real power order step change. Upon a step increase in the power order, the synchronizing angle will increase. This makes the q-axis voltage component negative. In turn, the real current order increases due to the cross-coupling unit from the q-axis voltage component to the real current order. This reaction can help increase the real power measurement to follow the power order. On the other hand, a negative q-axis voltage component makes the negative reactive current reference increase, or the reactive current reduce. This effect causes voltage to drop, which in turn reduces real power—an outcome that contradicts the intended goal.

Third, the control has difficulty riding through low-voltage grid faults. During a deep grid voltage dip, the real current may increase due to the d-axis PI control logic, which uses the d-axis voltage component as its input. If a reduction in grid voltage leads to increased real current injection, the IBR voltage will drop further. This behavior is a known flaw of grid-following controllers. Furthermore, a deep dip in the grid voltage may cause the IBR current hitting limits. When the grid voltage recovers back to normal, the q-axis PCC bus voltage component immediately reduces. This causes the real current to further increase due to the cross-coupling unit from the q-axis voltage component to the real current order. Due to the current limit, the real current cannot increase any more. Therefore, the outer control no longer can achieve its goal of angle tracking. The IBR may lose synchronism.

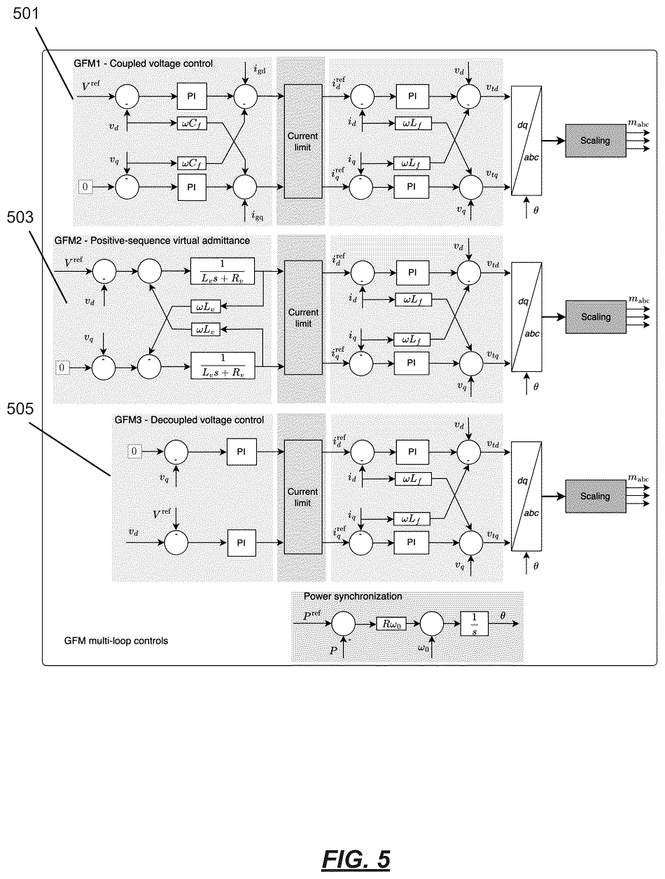

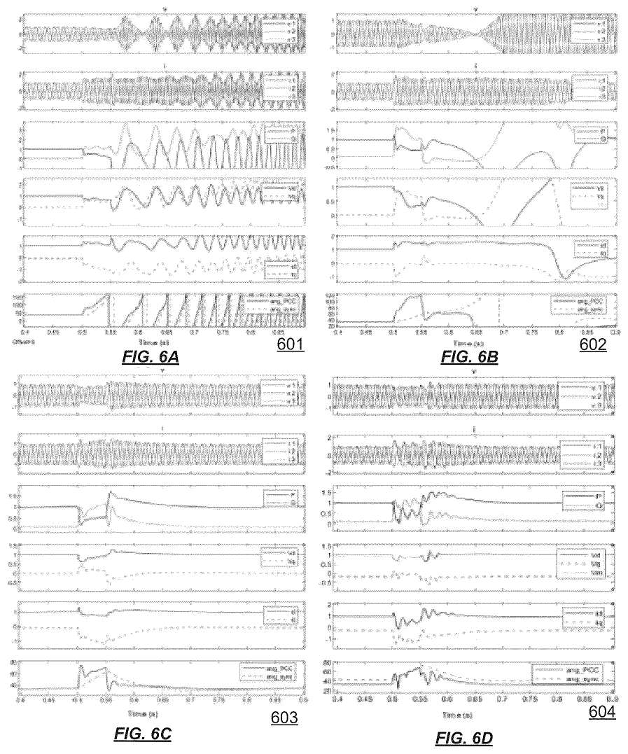

FIG. 6B shows a graph 602 of EMT simulation results of an IBR with coupled voltage control for a deep grid voltage dip. The IBR loses synchronism mainly due to increased real current injection and limit hitting.

### 2.2 Virtual Admittance Control

The control philosophy of virtual admittance 503 is to keep the inner current control while designing an outer control that can make the IBR act as a voltage source behind a virtual impedance. This design is to translate a circuit equation into a control block. The voltage order is the sum of the PCC bus voltage and the voltage drop on a virtual impedance.

The control structure exactly reflects the circuit design philosophy and adds a virtual impedance behind the PCC bus and the inverter's terminal bus. Therefore, the IBR operates as a voltage source behind the virtual impedance and can provide instantaneous fault currents. The IBR can also ride through low-voltage grid fault smoothly, as shown in the graph 604 of FIG. 6D. This voltage source characteristic ensures that its real power decreases, while the reactive power increases for a sudden grid voltage drop. Its power-based synchronization unit detects the increased error between the power order and the measured power, leading to an increase in the synchronization angle. When the grid voltage recovers, the real power rises while the reactive decreases, causing the angle to decrease to its pre-fault value.

### 2.3 Decoupled Voltage Control

The design philosophy of decoupled voltage control 505 is to make minimal edits of the GFL control, while realizing frequency and voltage support. The GFL's inner current control and q-axis outer control for reactive power or voltage regulation can be kept intact if the dq frame used for control aligns with the PCC bus voltage vector. With a PLL being replaced by a power-based synchronization unit to generate a synchronizing angle, additional changes should be made to d-axis outer control in a GFL.

Since the dq frame should align with the PCC bus voltage space vector, then the q-axis voltage component should be enforced to zero. Previously, this is the job of a PLL in a GFL and the q-axis outer control of the couple-voltage GFM. In the new design, the d-axis outer control ensures angle tracking and frame alignment. In the case of PLL, the q-axis voltage component is passed through a PI unit and an integral unit to generate the synchronizing angle.

In this new design, the synchronizing angle is already managed, so the q-axis voltage component should be driven to zero to ensure that the PCC bus voltage phase angle tracks the synchronizing angle. This is accomplished by adjusting the real current, as increasing real current injection helps raise the PCC bus voltage phase angle.

A positive q-axis voltage indicates that the PCC bus voltage vector leads the synchronizing frame, meaning the PCC voltage phase angle must be reduced while the synchronizing angle may need to increase. To achieve this, the d-axis outer control uses the negative of the q-axis voltage component as the input to its PI controller, generating the real current reference. A positive q-axis voltage results in reduced real current, which lowers real power output and increases the synchronizing angle.

Simultaneously, the real current reduction also decreases the PCC bus voltage angle. Thus, this control logic effectively supports the goal of achieving phase angle alignment. This design is very suitable for fault ride-through. While the IBR still operates as a current source, its behavior upon a dip in the grid voltage is similar as that of a voltage source. A dip in the grid voltage immediately leads to the PCC bus voltage magnitude reduction and angle increase. This in turn makes the real current reduce since the q-axis voltage increases. It also makes the reactive current increase since the d-axis voltage decreases. Both help ride through the fault.

FIGS. 6A-6D illustrate graphs 601, 602, 603, and 604 of low-voltage ride through tests for the IBRs described herein. The grid voltage is subject to a deep dip. FIG. 6A illustrates a graph 601 for the GFL. FIG. 6B illustrates a graph 602 of the coupled voltage control. FIG. 6C illustrates a graph 603 of the decoupled voltage control. FIG. 6D illustrates a graph 604 of the virtual admittance control and shows that the behavior of the real and reactive currents upon the fault is similar as that of an IBR operating as a voltage source.

### 3. Operation in a Series Compensated Network

It is very common to have series compensation in transmission networks. Series compensation is essentially a series capacitor which can effectively reduce the reactance at the nominal frequency or shorten the electrical distance. This technology enables higher power transfer capability. Series compensation is most popular for long-distance transmission. The bulk power systems in Texas, Finland, and Chile are known to have a significant number of series compensated transmission lines. Therefore, it is imperative to test an IBR's performance in series compensated networks and understand any potential stability issues.

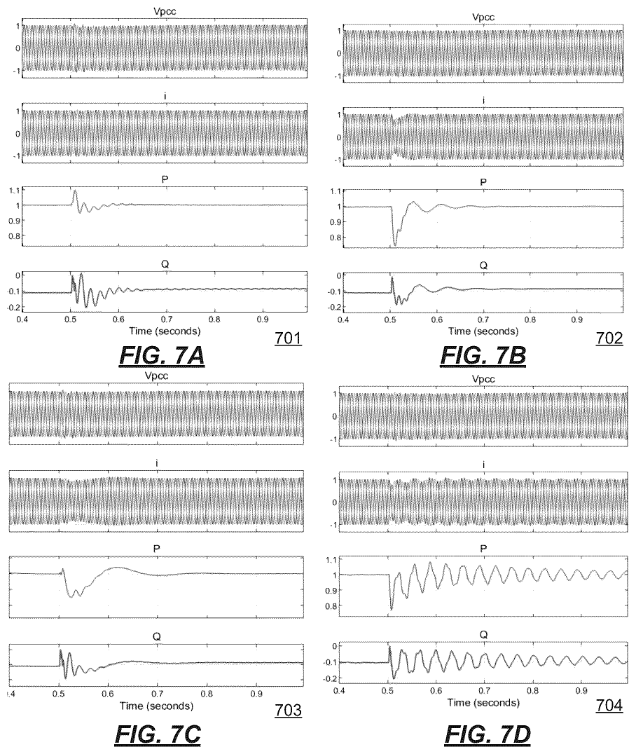

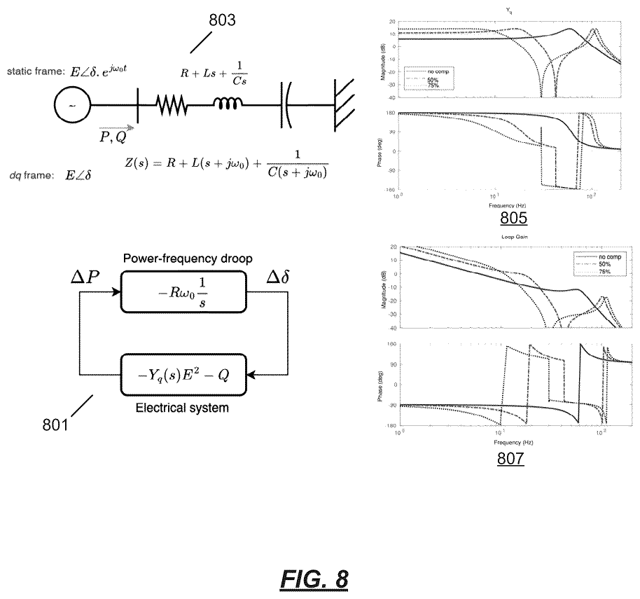

The four IBRs are tested for operation in a series compensated transmission grid. A worst-case scenario is created by tripping a parallel line and having the IBR radially connected to a 50% compensated line. FIGS. 7A-7D illustrate graphs 701, 702, 703, and 704 of simulation results of an IBR radially connected to a 50% compensated line at 0.5s. It can be seen from the graphs of FIGS. 7A-7D that while the GFL (FIG. 7A), the couple voltage GFM (FIG. 7B), the decoupled voltage GFM (FIG. 7C) have no issues operating in such a condition, the virtual admittance GFM (FIG. 7D) experiences sub-synchronous oscillations.

The prior operating experiences implicate that subsynchronous resonances (SSR) usually occur in an RLC circuit powered by voltage sources, while not in such a circuit powered by current sources. SSRs have been observed in both synchronous generators and type-3 wind farms, while not in type-4 wind farms. The underlying reason is that when an RLC circuit is driven by a voltage source, its phase current exhibits an LC resonance mode in the subsynchronous frequency range. If the source has a negative resistance at this LC mode, undamped oscillations may appear. This phenomenon has been termed as induction generator effect. The LC mode manifests as a sub-synchronous mode and a super-synchronous mode in the root-mean-squared (RMS) measurements and power measurements. It is easy for the subsynchronous mode to interact with mechanical modes, thereby causing subsynchronous torsional interactions (SSTI) in synchronous generators. When the RLC circuit is driven by a current source, the phase voltage will not show any LC mode. Therefore, for sources acting as a current source, SSR is usually not an issue.

The correlation between the source characteristics and SSR makes it necessary to check an IBR's operation in a series compensated network. Among the three GFMs, the virtual admittance GFM is mostly aligned with a voltage source. Therefore, with all the benefits brought by the voltage source characteristics (e.g., instantaneous fault currents, robust fault ride-through), this GFM-IBR does have one shortcoming compared to current source-based converter controls. The GFM-IBR is vulnerable to SSR in series compensated networks. Its power-based synchronization makes SSR worse.

FIG. 8 is an illustration of a power-angle feedback system 801 representing an RLC circuit 803 driven by a voltage source equipped with power-based synchronization. The two Bode diagrams 805 and 807 illustrate that the imaginary grid admittance has additional phase lag due to series compensation, which leads to the overall open loop gain experiencing phase shift in the subsynchronous frequency region. SSR may occur if the loop gain's magnitude is greater than 0 dB at this frequency.

FIG. 8 shows the effect of the angle-power feedback system. The imaginary of the complex grid admittance influences the dynamic performance of the system. Compared to a circuit without series compensation, a circuit with series compensation introduces more phase lag in the subsynchronous frequency region of the imaginary grid admittance. With the additional phase lag introduced by the P-f droop control, the system with series compensation may be subject to oscillations.

### 4. Hardware Prototyping Results

The GFM-IBR with decoupled voltage control provides better fault ride-through capability compared to a GFL-IBR and can operate in a network with series compensation. The control can be retrofitted from GFLs by the control algorithm update only without hardware upgrading. This controller has been prototyped in a real-time controller National Instrument's Compact Reconfigurable Input/Output (cRIO) 9049, and tested in a hardware setup. The cRIO is essentially an industrial computer that reads data from sensors, processes data through control algorithms, and sends out commands to actuators. In this case, the NI cRIO 9049 provides real-time signal processing capabilities and a high-speed FPGA operating at 40 MHz. The control algorithm is implemented in LabVIEW software on a computing device connected to the cRIO, compiled into executable codes and embedded into the cRIO. This cRIO now acts as a real controller that can take input signals (instantaneous voltage and current measurements) and outputs gate signals to drive the inverter. Suitable controller and/or computing devices include the computing device 1100 illustrated with respect to FIG. 11.

The single-IBR infinite-bus system has been implemented in a hardware testbed set up in the Smart Grid Power Systems (SPS) Lab at the University of South Florida (USF). The IBR is represented by a three-phase silicon carbide MOSFET-based voltage source converter (VSC) module driven by a DC voltage source. This VSC module has a rated 800 V DC voltage and is capable of handling current up to 24 A. Its switching frequencies of up to 200 kHz. The choke filter and transmission line are realized with inductors and a 400-V, 47-μF capacitor serves as the shunt filter capacitor.

To emulate an infinite bus or a main power grid, a Chroma regenerative grid simulator has been employed, offering programmable and bidirectional operation up to 45 kVA. It provides a stable three-phase voltage output of 400 V per phase. Critical measurements for the VSC control, including PCC bus voltages and exported currents, are acquired using the OPAL-RT OP-8662 voltage and current sensors, featuring eight voltage and current channels capable of measuring up to 600 V and 15 A, respectively. These measured signals are interfaced with the control hardware via NI 9205 analog input modules connected to an NI cRIO 9049 real-time embedded controller.

### 4.1 Low Voltage Ride-Through

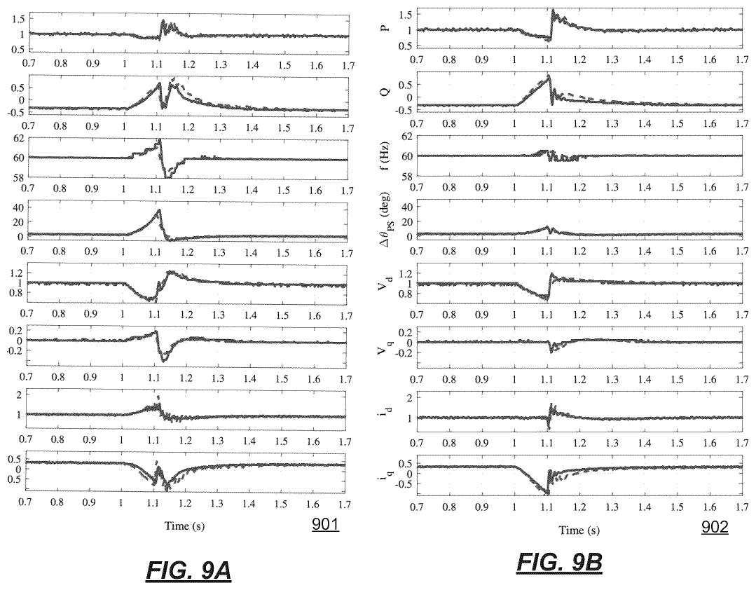

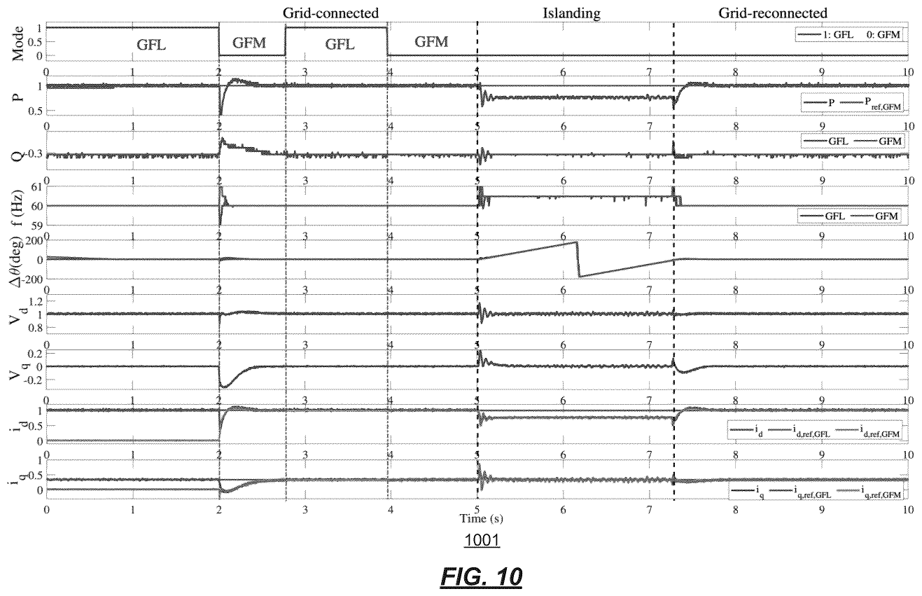

A balanced grid voltage 30% dip event lasting for six cycles, was experimentally and numerically investigated. The experiment and simulation results are shown in the graphs 901 and 902 of the FIGS. 9A and 9B.

In the GFL control case, the synchronization relies on a PLL, which inherently forces the steady-state q-axis voltage component to zero. Upon the voltage dip, the d-axis voltage component immediately decreases, while the q-axis voltage experiences an increase. This reflects an instantaneous angular shift of the PCC voltage vector, compelling the PLL to track this angular displacement, resulting in considerable variations in the PLL frequency and synchronization angle.

In contrast, the GFM decoupled voltage control exhibits significantly fewer transients in both frequency and angle compared to the GFL. During the voltage dip, the synchronizing angle in the GFM increases gradually due to the reduced real power. Experimental and simulation results indicate that the synchronization angle remains closely aligned with the PCC voltage vector. Furthermore, the GFM control provides notable frequency support through real power adjustments, which contributed to more pronounced transient variations in real power compared to that of the GFL.

### 4.2 Seamless Control Mode Switching

The GFL and the GFM with decoupled voltage control can be implemented in a single controller. They may share the same inner current control, q-axis outer control, while switching back and forth by using the synchronizing angle generated by PLL and the real current reference generated by the real power regulation for GFL, or the angle generated by the power-based synchronization and the real current reference generated by frame alignment for GFM.

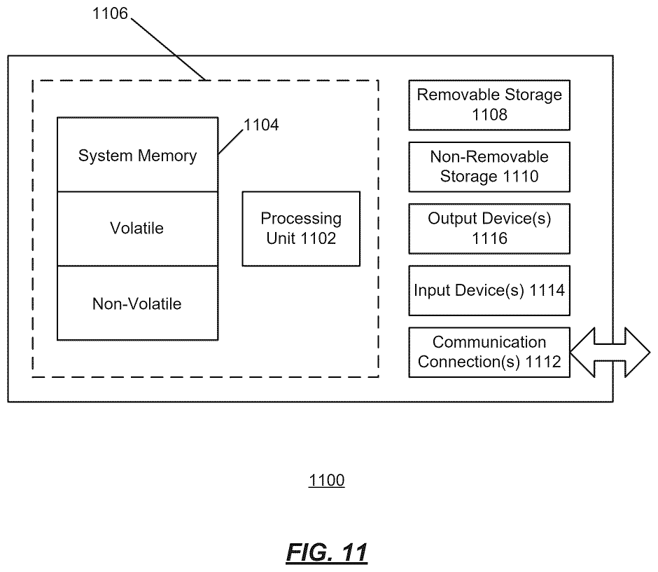

FIG. 10 is an illustration of a graph 1001 showing the experimental results of switching back and forth of the control mode from one to another for grid-connected operation. At 5 seconds, the IBR disconnects from the main grid and serves a local load, while operating in the GFM control mode. The power-frequency droop control forms a microgrid with its own frequency (greater than 60 Hz) and operates without any issue. After a while, when the IBR and the main grid are connected once again, the microgrid synchronizes to the main grid. The frequency recovers back to 60 Hz. The prototyping and hardware experimental results confirm that the vector control-based GFM design is feasible and can be manufactured to provide better grid supporting capability.

### 5. Example Computing Environment

With reference to FIG. 11, an example system for implementing aspects described herein includes a computing device, such as computing device 100. In its most basic configuration, computing device 600 typically includes at least one processing unit 1102 and memory 1104. Depending on the exact configuration and type of computing device, memory 1104 may be volatile (such as random access memory (RAM)), non-volatile (such as read-only memory (ROM), flash memory, etc.), or some combination of the two. This most basic configuration is illustrated in FIG. 11 by dashed line 1106.

Computing device 1100 may have additional features/functionality. For example, computing device 1100 may include additional storage (removable and/or non-removable) including, but not limited to, magnetic or optical disks or tape. Such additional storage is illustrated in FIG. 11 by removable storage 1108 and non-removable storage 1110.

Computing device 1100 typically includes a variety of computer readable media. Computer readable media can be any available media that can be accessed by the device 1100 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 1104, removable storage 1108, and non-removable storage 1110 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1100. Any such computer storage media may be part of computing device 1100.

Computing device 1100 may contain communication connection(s) 1112 that allow the device to communicate with other devices. Computing device 1100 may also have input device(s) 1114 such as a keyboard, mouse, pen, voice input device, touch input device, etc. Output device(s) 1116 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although example implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A grid forming controller with decoupled voltage control comprising:
a decoupled voltage control as an outer control unit;
a power-based synchronization unit; and
an inner current control unit, wherein the controller receives measurements from an inverter, the measurements including three-phase instantaneous PCC voltage and three-phase instantaneous converter currents, and outputs pulse width modulation signals for the inverter.

2. The grid forming controller of claim 1, wherein the outer control unit comprises a d-axis control component and a q-axis control component, wherein the d-axis control component drives the q-axis component of the voltage vector to zero.

3. The grid forming controller of claim 2, wherein the q-axis control component regulates reactive power or voltage magnitude and it comprises a PI controller.

4. The grid forming component of claim 3, wherein the PI controller of the q-axis control component outputs a q-axis component of a current reference.

5. The grid forming component of claim 4, wherein the q-axis inner control unit receives the q-axis component of the current reference and ensures the q-axis current measurement tracking the reference.

6. The grid forming controller of claim 2, wherein the d-axis control component comprises a PI controller, and further wherein the PI controller receives as an input a negative of the q-axis component of the voltage vector.

7. The grid forming controller of claim 6, wherein the PI controller of the d-axis control component outputs a d-axis (or real) current reference.

8. The grid forming component of claim 7, wherein the d-axis control component receives the d-axis (or real) current reference and ensures the real current measurement tracking the reference.

9. The grid forming controller of claim 1, wherein the wherein the power-based synchronization unit generates a synchronization angle based on a power output from the inverter and sets up the dq frame.

10. The grid forming controller of claim 1, wherein the inverter is associated with one or more of a solar panel, a wind turbine, or a battery.
